(19) United States
(12) Patent Application Publication
(10) Pub. No.: US 2024/0389526 A1
(43) Pub. Date: Nov. 28, 2024

(54) Device and Method for Providing Nutrients to Plants and Fungi

(71) Applicant: FRAUNHOFER-GESELLSCHAFT ZUR FÖRDERUNG DER ANGEWANDTEN FORSCHUNG E.V., München (DE)

(72) Inventors: Simon Vogel, Aachen (DE); Stefan Schillberg, Aachen (DE)

(21) Appl. No.: 18/691,013

(22) PCT Filed: Sep. 12, 2022
(86) PCT No.: PCT/EP2022/075231

§ 371 Date: Mar. 11, 2024

(30) Foreign Application Priority Data
Sep. 13, 2021 (EP) 21196343.4

(51) Int. Cl. A01G 31/04; A01G 18/69; A01G 27/00

(52) U.S. Cl. CPC A01G 31/042; A01G 18/69; A01G 27/003

(57) ABSTRACT

A device and method for irrigating and providing nutrients to plants and fungi, having a supply unit, which has an inlet that can be connected at least indirectly to a water and/or nutrient solution supply and which has an outlet through which water and/or nutrient solution can be dispensed in at least two locations that are positioned at different heights with respect to a vertical. The solution features the fact that the supply unit has a drive train (8), which can be connected to a drive unit, and at the outlet, has at least one nozzle, which is coupled to the drive train and is for dispensing the water and/or nutrient solution, wherein based on an activation of the drive train, the nozzle is movable to at least two locations positioned at different heights.

### TECHNICAL FIELD

The invention relates to a device and method for providing nutrients to plants and fungi with a supply unit, which has an inlet that can be connected at least indirectly to a water and/or nutrient solution supply and which also has an outlet through which water and/or nutrient solution can be dispensed into a vicinity in at least two points that are positioned in an at least approximately vertically oriented plane.

### BACKGROUND OF THE INVENTION

In general, various systems are known from the prior art that enable an automated cultivation of plants or fungi, in particular crops. The essential feature of the known systems is that plants are grown in a comparatively small space while at the same time making effective use of water, nutrient solution, and energy since the systems are usually located in rooms with conditions that can be optimized for the growth of the plants, in particular with regard to the prevailing climate, light, and supply of water and nutrients. The known systems make it possible to grow plants or fungi almost independently of weather and season. The use of special systems for water recovery also means that significantly less water is required to grow the plants than when cultivating fields outdoors. In addition, comparatively little fertilizer is required and growing plants in fully climate-controlled rooms makes it possible to cultivate plants without pesticides.

The systems for cultivating and growing greenhouse crops, such as for tomatoes, cucumbers, and lettuce, that have become increasingly popular in recent decades enable the mass production of agricultural products in fully climate-controlled rooms with strict control of external influences. In this context, systems for growing plants or fungi are known in which the plants or fungi are arranged in a shelving system, automatically supplied with nutrient solution during the growth phase, moved at least occasionally during their growth, and exposed to illumination with spectrally tuned light.

WO 2010/008335 A1 discloses a system for automated plant cultivation in which the plants are arranged in plant cultivation containers and conveyed from bottom to top and from top to bottom on sloped sections. In addition, the plants are illuminated during their movement by a lighting device and supplied with water or nutrient solution by an irrigation system. Irrigation is carried out in such a way that the plant growing containers are arranged in trays that can be filled with water or nutrient solution and have openings through which the water or nutrient solution in the trays enters the containers in the direction of the plants' root systems. The irrigation in this case is carried out in such a way that the plant growing containers are arranged in trays that can be filled with water or nutrient solution and have openings through which the water or nutrient solution in the trays enters the containers in the direction of the root system of the plants.

US 2009/1653731 also discloses a system for automated plant cultivation in which plants are arranged on support rails provided for this purpose on a rotating drum. The plants are arranged in such a way that their foliage or fruits protrude into the interior of the drum so that the plants are conveyed so that they are upside down part of the time during the rotation of the drum. In this technical solution, the moving plants are supplied with water and/or nutrient solution by a tray arranged in the bottom region of the system, through which the root system of the plants that are currently in this area is moved.

What both systems described above for automated plant cultivation have in common with regard to irrigating the plants is that the root system is brought into direct contact, at least intermittently, with water or nutrient solution that is stored in a tray. Such an irrigation device is also referred to as a hydroponic system.

Furthermore, EP 3 409 103 A1 discloses a system for automated plant cultivation that enables particularly effective and flexible cultivation of plants that are anchored to a conveyor belt moving along a conveyor line. In this case, the plants are anchored to the conveyor belt in such a way that the foliage on an upper side and the root system on an underside of the conveyor belt opposite from the upper side protrude beyond the conveyor belt.

The conveyor line also has at least approximately vertically positioned conveyor sections on which the plants to be grown are moved from bottom to top and from top to bottom. The vertical conveyor sections can be circular or oval or part of a meandering conveyor line. The technical features described enable a particularly flexible design of an automated plant cultivation system since the lighting of the plants, the arrangement of the plants on the conveyor belt, and their supply with nutrients can be flexibly adapted to the respective requirements, in particular to the plant species to be grown and the growth phase.

A prototype system that implements the technical solution described above has been set up and already tested at the Fraunhofer Institute for Molecular Biology and Applied Ecology IME (Fraunhofer IME develops indoor plant production system; press release from the Fraunhofer Institute for Molecular Biology and Applied Ecology IME dated Sep. 21, 2020). This system has an aeroponic irrigation system in which the plant roots are suspended in the air during transportation and sprayed with water and nutrients there.

Based on the systems for automated plant cultivation known from the prior art, there is a general need for the supply units used to supply water and/or a nutrient solution to the plants to be grown to be efficient in terms of energy and water requirements and to have a structurally simple design. Aeroponic irrigation systems have therefore proven to be advantageous for providing nutrients to plants; the known aeroponic irrigation system supply units have a plurality of stationary nozzles arranged in a grid, through which water and/or nutrient solution is dispensed, sometimes in pulses, in the direction of the root system of the plants. One problem with these known supply units is that a large number of nozzles arranged in a distributed pattern are required to dispense a sufficient quantity of water and/or nutrient solution to the entire cultivation area in which the root systems of the moving plants are positioned. Due to the large number of nozzles and their arrangement, maintenance and repair work on the known irrigation systems is often difficult, especially since certain nozzles are difficult to access. In addition, long, branched pipe systems are frequently required in order to supply the large number of nozzles with water and/or nutrient solution at the required pressure.

A further problem arises from the fact that the pipe system filled with water and/or nutrient solution must be reliably prevented from running dry during pulsed operation or an interruption. For this reason, the nozzles that have been used up to now are usually equipped with comparatively expensive drip-stop valves. A further problem with the use of a large number of nozzles is that a significant number of nozzles fail at least occasionally over the entire operating time, in particular due to blockages, and the necessary repair or replacement is only possible at considerable expense.

Based on the technical solutions known from the prior art and the problems described above, the object of the invention is to modify a device for supplying plants or fungi, which, for cultivation purposes, are moved along the conveyor line of a system for automated plant/fungi cultivation in such a way that on the one hand, ensures an effective provision of water and/or nutrient solution to the plants or fungi and on the other hand, minimizes the technical complexity and also the manufacturing and operating costs for such an irrigation system. In this connection, it is particularly important that a large area can be reliably supplied with water and/or more solution using the smallest possible number of nozzles. In addition, the disclosed device for providing water and/or nutrient solution to moving plants/fungi should be easy to maintain and at the same time reduce the risk of repair work and the associated system outages or plant/fungi waste. It should also be possible to combine the disclosed supply system with known plant/fungi cultivation systems or to integrate it into them without extra design work, technical system costs, and/or economic complexity. Simple automation and largely trouble-free and economical operation of a device for supplying plants and/or fungi that are moved in a system for automated plant cultivation should also be ensured.

### SUMMARY OF THE INVENTION

The above-described object is attained by a device for providing nutrients according to claim 1 and by a method for providing nutrients according to claim 10. The above-described object is also attained by a system for the automated cultivation of plants and/or fungi disclosed in claim 14. Advantageous embodiments of the invention are the subject of the dependent claims and will be explained in greater detail in the following description with partial reference to some of the figures.

The invention relates to a device for providing nutrients to plants and fungi with a supply unit, which has an inlet that can be connected at least indirectly to a water and/or nutrient solution supply and which also has an outlet through which water and/or nutrient solution can be dispensed in at least two points or locations that are positioned at different heights with respect to a vertical. According to the invention, the device is characterized by the fact that the supply unit has a drive train, which can be connected to a drive unit, and at the outlet, has at least one nozzle, which is coupled to the drive train and is for dispensing the water and/or nutrient solution, the nozzle being movable to at least two of the locations positioned at different heights due to activation of the drive train.

The fact that the at least two points at which water and/or nutrient solution can be dispensed are positioned at different heights with respect to a vertical means that at least two dispensing points are different distances from a floor region in which the device for providing nutrients according to the invention is positioned. Preferably, the two dispensing points to which the nozzle can be moved are located in a plane that is oriented at least approximately vertically. It is also advantageously conceivable for the at least one nozzle to be movable to a plurality locations for the dispensing of water and/or nutrient solution so that with at least one nozzle, in particular only a small number of them, the dispensing of water and/or nutrient solution can take place over a comparatively large surface area. It is thus possible to reduce the number of nozzles required compared to the known technical solutions and it is preferably possible to eliminate a pulsed dispensing of water and/or nutrient solution.

Instead, according to the invention, in order to dispense water and/or a nutrient solution, a supply unit is provided with at least one nozzle, which is movable in at least the vertical direction and preferably in both the vertical and horizontal direction. According to a special modification, the movement of the at least one nozzle takes place in a plane, particularly preferably in an at least approximately vertical plane. In this context, it is advantageously conceivable for a plane in which the at least one nozzle is movable to be oriented at least approximately parallel to a plane in which the plants and/or fungi to be grown or cultivated, in particular their root system or mycelia, are located. With the aid of at least one nozzle that is embodied to be movable or displaceable in this way, the required quantity of water and/or of a nutrient solution containing at least one nutrient can be dispensed as needed in the at least two locations into the vicinity, particularly in an area in which the root systems of the plants or mycelia of the fungi are located.

Such a device can preferably be combined with or integrated into a system for automated plant/fungi cultivation, in which plants and/or fungi to be grown or cultivated are moved along a conveyor line at least in sections in at least one subsection that is oriented vertically or obliquely to the vertical. For this purpose, the device according to the invention has at least one nozzle that is movable or displaceable with the aid of the drive train, which can be connected to a suitable drive, in such a way that water and/or nutrient solution can be dispensed in the region of the vertical conveyor line sections in at least two locations, which are located at different heights with respect to a vertical or the floor region on which the device is positioned.

Preferably, the at least one nozzle is supplied with water and/or nutrient solution via at least one suitable tube and/or hose, the supply system with the tube and/or hose being designed flexibly on the whole such that the at least one nozzle can be supplied with the required quantity of water and/or nutrient solution at different locations. It is particularly advantageous if at least one delivery unit, in particular a pump, turbo, and/or nozzle unit, is flow-connected to the tube and/or hose in such a way that at least one flow parameter, in particular the pressure and/or flow rate of a water and/or nutrient solution flowing through the tube and/or hose, can be selectively varied, preferably adjusted to a desired value.

A nozzle provided according to the invention is embodied in such a way and can be moved by the drive train in such a way that when the device for providing nutrients is combined with or is part of a system for automated plant cultivation, it dispenses water and/or a nutrient solution in the direction of the root system of the plants to be grown and/or the mycelia of the fungi. In this context, it is conceivable to design the nozzle in such a way that water and/or nutrient solution can be dispensed in the direction of the root system in the form of a jet, a spray mist, and/or an aerosol, which accordingly contains droplets of water and/or nutrient solution. It is particularly advantageous if the at least one movably arranged nozzle can be adjusted in a suitable manner so that the jet shape with which the water and/or nutrient solution is dispensed can be varied as needed.

In a preferred embodiment of the invention, the drive train has at least one at least approximately vertically oriented guide to which the nozzle is at least indirectly connected and in relation to which the nozzle can execute a relative movement. The at least one guide preferably has at least one guide rail, preferably a frame formed by at least two approximately vertically oriented guide rails, with a travel path along which the nozzle, which is preferably fastened to a suitable nozzle holder, can be moved.

In an advantageous manner, the at least one guide rail is at least indirectly connected to a part of the drive train, in particular to a drive element, for example in the form of a toothed rack, along which the nozzle or a nozzle head holder to which the nozzle is attached can be moved. Preferably in this case, a pinion engaging with the toothed rack is provided on at least one end of the nozzle head holder. But other drive elements are also conceivable in this context, which enable a movement of the nozzle or of the nozzle head holder together with the nozzle along the at least one guide rail. It is thus conceivable for at least one traction or pressure element, for example a traction cable or piston, to be provided inside or outside the guide rail, which element enables the nozzle, in particular the nozzle holder connected to the nozzle, to be selectively moved along the guide rail. The required energy, which is provided in the form of electrical energy, compressed air, and/or a hydraulic fluid, is preferably supplied via flexible hose lines, which enable unhindered movement of the nozzle relative to the at least one guide rail.

In a very special embodiment of the invention, at least two guide rails are provided, which are positioned on both sides of a strut embodied as a nozzle holder, wherein the strut together with the nozzle can be moved upward and downward in a vertical direction relative to the guide rails extending in a vertical direction. The drive train used in each case is thus advantageously embodied in such a way that the at least one nozzle and/or the nozzle holder to which at least one nozzle is attached is moved in a vertical direction. It is also conceivable for the nozzle to be also movable in the horizontal direction simultaneously or at a later point, for example along a nozzle holder that can have a horizontal strut.

According to a special modification of the invention, the movement of the at least one nozzle takes place at a constant speed. Alternatively or additionally, it is conceivable for the movement to be at least intermittently accelerated or interrupted.

It is particularly advantageous if the movement direction, speed, and/or acceleration of the nozzle is adjusted as needed with the aid of a controller, in particular depending on the plants or fungi to be supplied with water and/or nutrient solution and/or the respective growth phase that the plants or fungi are in. It is also advantageously conceivable for at least one swivel or folding mechanism to be positioned between the at least one nozzle and/or a nozzle head holder and a guide rail connected at least indirectly thereto, which ensures that the nozzle and/or the nozzle holder with the nozzle attached thereto can be swiveled or folded in a relatively simple way into a maintenance or repair position. In this context, it is conceivable for the folding or pivoting mechanism to be designed in such a way that a strut serving as a nozzle holder is folded or pivoted in the direction of one of the guide rails and is thus oriented at least approximately parallel to the guide rail in the maintenance or repair position and the at least one nozzle can be reached relatively easily from one side.

In any case, it is advantageous if the at least one nozzle, which is preferably selectively movable or displaceable within an at least approximately vertically oriented plane, can be swiveled or folded into a position that enables easier maintenance, repair, or replacement of the nozzle.

In a particular modification of the invention, the drive train, which can produce a selective movement of the at least one nozzle to at least two locations that are spaced apart from each other and preferably lie in one plane, has at least one support arm with at least one articulation, the nozzle being at least indirectly fastened to the support arm. In this case, it is preferably conceivable for the support arm to which the at least one nozzle is fastened to be part of an industrial robot that is able to move the nozzle relatively quickly and precisely at different times to at least two locations, which are preferably positioned in a vertical plane, in order to dispense water and/or nutrient solution into the vicinity, in particular a vicinity in which the root system of plants or mycelia of fungi, which are moved with the aid of an automated plant propagation system, are located. By using a suitable robotic arm, which can be part of an industrial robot, it is advantageously possible on the one hand to properly move a nozzle and/or a special arrangement of nozzles with or without a nozzle holder in the desired manner and on the other hand to ensure precise positioning.

According to another special modification of the invention, the supply unit has at least one delivery element by means of which a pressure and/or flow rate of a water and/or nutrient solution flow, which is provided by a nutrient solution supply and is to be delivered to the at least one nozzle, can be selectively varied at least in certain areas. The delivery element can be a pump in the form of a radial, screw, worm, or piston pump, a jet compressor, and/or a turbo compressor. It is essential for this embodiment that the set values for pressure and/or flow rate of a water and/or nutrient solution flow conveyed to the at least one movable nozzle, which can preferably be preset via a controller, can be adapted in a suitable manner, in particular depending on the type of plants and/or fungi to be supplied, the respective growth phase, and/or a predetermined day-night rhythm. In this context, it is conceivable for the flow form of the water and/or nutrient solution flow to be set as laminar or as a turbulent flow as needed and/or for the temperature and/or composition of the water and/or nutrient solution flow prevailing in the supply line leading to the at least one nozzle to be selectively adjusted by means of suitable elements such as heating elements and/or flow obstacles

According to a particular embodiment of the invention, the drive train can be coupled to a drive with at least one electric, pneumatic, and/or hydraulic drive unit. The invention thus also relates to a device embodied according to the invention for providing water and/or nutrients, which is coupled to an electric, pneumatic, and/or hydraulic drive unit for activating the drive train and moving the at least one nozzle. When implementing this embodiment, it is also particularly advantageous if the drive train is coupled to a drive with at least one hydraulic drive unit for activation, to which water and/or nutrient solution from the nutrient solution supply is at least occasionally supplied as a drive fluid. According to these special embodiments, the water and/or nutrient solution provided by the nutrient solution supply, for example a branched supply system and/or a tank, is used to introduce energy into at least one drive unit in order to thus activate the drive train and set the at least one nozzle in motion. In this case, a suitable pressure boosting unit is preferably provided in order to at least intermittently supply the drive unit with a flow of water and/or nutrient solution with the hydraulic energy required for the desired movement of the at least one nozzle.

In a very special embodiment of the invention, at least one sensor and/or one control unit is provided so that at least one operating parameter of a device embodied according to the invention can be detected during the irrigation and/or provision of nutrients to the plants or fungi to be grown and can be used as a basis for controlling the irrigation and/or provision of nutrients in a suitable manner. Preferably, at least one position, speed, and/or acceleration sensor is used to detect the corresponding speed, acceleration, and/or a position at which the movable or displaceable nozzle is located and, if necessary, to use this as a basis for further control of the nozzle and/or drive train. It is also conceivable, alternatively or additionally, for a sensor to be provided that detects at least one flow parameter, in particular a pressure, a flow velocity, and/or a flow shape.

It is also conceivable for at least one sensor to be provided that detects a temperature, density, and/or composition of the conveyed water and/or nutrient solution and/or at least one operating parameter of the drive train and/or of a nozzle connected to the drive train, particularly in order to use the detected measured value(s) as the basis for a control or regulation of a device according to the invention for irrigating and/or providing nutrients to plants or fungi. The sensor data can be used as a basis for making recommendations for nozzle maintenance or for detecting malfunctions thereof.

In addition, the invention also relates to a method for irrigating and/or providing nutrients to plants and fungi, in which water and/or a nutrient solution is supplied to a supply unit and the water and/or nutrient solution is dispensed from an outlet of the supply unit to a vicinity in which the plants and/or fungi are positioned in at least two locations, which are at different heights with respect to a vertical, i.e. at different heights with respect to a floor on which the device is erected. The method according to the invention features the fact that at least one nozzle is moved by a drive train, which can be activated by a drive, to at least two of the locations positioned at different heights in order to dispense the water and/or nutrient solution. Preferably, the two locations to which the at least one nozzle is moved are located in an at least approximately vertical plane.

For the method according to the invention, it is thus essential for the supply unit to have at least one nozzle that is moved to at least two locations that are positioned at different heights with respect to a vertical and particularly preferably are located in an at least approximately vertically oriented plane. By means of the method according to the invention, an effective and rapid supply of plants and/or fungi, which are moved at least partially along an at least approximately vertically extending conveyor section in a system for automated plant/fungi cultivation, is achieved through a suitable movement of at least one nozzle, preferably a plurality of nozzles. Since the plants or fungi are supplied by means of at least one moving nozzle, it is not necessary to use a large number of nozzles, particularly in a pulsed operation, to ensure the desired irrigation and/or provision of nutrients to plants or fungi that are moved during growth. In particular, this significantly reduces the amount of maintenance, repair, and replacement work required.

According to an advantageous embodiment of the method according to the invention, the at least one nozzle is moved at least approximately parallel to a plane in which the moving plants or fungi to be grown or cultivated are positioned. The movement takes place in a vertical and, particularly preferably, in a vertical and horizontal direction, whereby the at least one nozzle can be moved simultaneously or successively in a vertical and horizontal direction. In this way, the nozzle is preferably moved upward and/or downward and/or sideways within an at least approximately vertically oriented plane.

Furthermore, it is preferably conceivable for the nozzle to be moved at a constant speed at least during a movement between two reversal points. Depending on the type of plants or fungi to be cultivated or the growth phase they are currently in, it is alternatively conceivable for the at least one nozzle used to be at least intermittently accelerated or operated with pauses in movement. It is also advantageous if the water and/or nutrient solution is dispensed into the vicinity in which the plants and/or fungi are positioned with a varying pressure, flow rate, and/or jet shape. In this case, the pressure, flow rate, and/or jet shape is preferably varied in such a way that the plants or fungi to be grown are acted on as needed with a jet of water or nutrient solution, atomized water, and/or nutrient solution, or an aerosol containing droplets of water and/or nutrient solution.

The invention also relates to a system for automated plant and fungi cultivation with a device which is designed in accordance with at least one of the embodiments described above and/or which is suitable for implementing the method described above in accordance with at least one of its embodiments.

A device according to the invention and a corresponding method are thus advantageously suitable for being combined with or integrated into a system for automated cultivation of plants or fungi. In this case, it is particularly advantageous if the system has at least one conveyor section on which the plants and/or fungi to be grown are moved upward or downward in an at least approximately vertical direction. It is advantageously also conceivable for the plants and/or fungi to be anchored relative to a conveyor belt moving along the conveyor line in such a way that the root system of the plants and mycelia of the fungi project beyond the surface of the conveyor belt on one side of the conveyor belt so that the root system is at least intermittently provided with water and/or nutrient solution by means of a device embodied according to the invention and/or by means of a method embodied according to the invention. It is essential to the invention that a respective device, method, and system are provided in which at least intermittently vertically moving plants or fungi are suitably provided with water and/or nutrient solution by at least one movable nozzle. In this case, it is particularly advantageous if the plants or fungi to be grown are situated on a conveyor belt moving along the conveyor line and are anchored in the conveyor belt in such a way that as they are moved along the conveyor line, the plants and/or fungi are subjected to a constant orbitropal reorientation, i.e. a constant reorientation with respect to the Earth's gravitational field acting in the direction of the Earth's center of gravity.

### BRIEF DESCRIPTION OF DRAWINGS

The invention will explained in greater detail below without limitation to the general concept of the invention, based on specific exemplary embodiments and with reference to figures. In the various figures, components that are the same are each provided with the same reference symbols. In the drawings:

FIG. 1: shows a schematic depiction of the device according to the invention for providing plants and/or fungi with water and/or nutrient solution with a movable nozzle holder to which five nozzles are fastened,

FIG. 2: shows a schematic depiction of the device according to the invention for providing plants and/or fungi with water and/or nutrient solution with a conveyor belt and cultivated crops,

FIG. 3: shows a schematic depiction of the device according to the invention for providing plants and/or fungi with water and/or nutrient solution with a movable nozzle holder, which is pivoted into a maintenance position,

FIG. 4: shows a schematic depiction of the device according to the invention for providing plants and/or fungi with water and/or nutrient solution with a nozzle, which can be moved along a vertical guide rail, and

FIG. 5: shows a schematic depiction of the device according to the invention for providing plants and/or fungi with water and/or nutrient solution with a pipe, which can be moved vertically along the irrigation area and is provided with a plurality of nozzles.

### DETAILED DESCRIPTION OF THE INVENTION

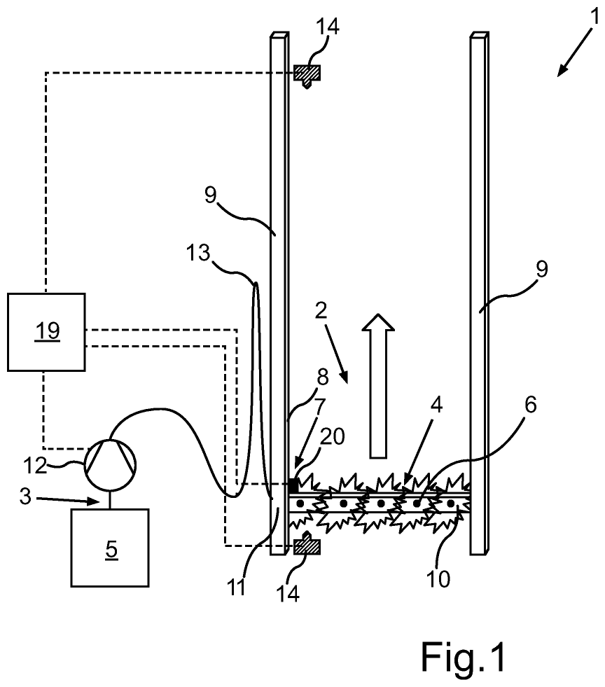

FIG. 1 shows a schematic depiction of the basic structure of a device 1 embodied according to the invention, which is suitable for providing nutrients to crops such as plants and fungi. The device 1 has a supply unit 2 with a plurality of nozzles 6 for dispensing water and/or nutrient solution; according to the exemplary embodiment shown here, there are five nozzles 6, which are coupled to a drive 7 via a drive train 8. The five nozzles 6 shown in FIG. 1 are fastened to a nozzle holder 10 in the form of a strut and both ends of the strut are accommodated in guide rails 9 in such a way that the nozzle holder 10 together with the nozzles 6 fastened to it can be moved upward and downward in the vertical direction along the two guide rails 10. As part of the drive train 8, a drive element is provided in at least one of the guide rails 9, in this case in the guide rail 9 on the left in FIG. 1, which enables selective movement of the nozzle holder 10 relative to the guide rail 9. The drive element can be a pinion that cooperates with a toothed rack fastened to the guide rail. It is also conceivable for the drive train 8 to have a tension element, such as a cable, wire, or chain, or a pressure element, such as a piston, which is used to initiate a selective movement of the nozzle holder 10 with the nozzle 6 relative to the guide rails 9.

According to the embodiment described here, the drive 7 coupled to the drive train 8 and thus to the drive element provided in the guide rail 9 and/or on the nozzle holder 10 has an electric motor that is supplied with electrical energy and sets the drive element at least intermittently in motion in the desired manner.

Alternatively, it is conceivable to cause a nozzle holder 10 to move by providing a hydraulic or pneumatic drive 7 (e.g. by means of the hydrodynamic pressure of the nutrient solution).

The nozzles 6 shown in FIG. 1, which are fastened to the nozzle holder 10, are connected to a tubular supply line 13, via which the water or nutrient solution required to supply the plants or fungi is fed to the nozzles 6 from a central water and/or nutrient solution supply 5. In this case, the water and/or nutrient solution is delivered to the nozzles 6 by means of a pump provided as a delivery element 12, which can be controlled by means of the control unit 19. The pressure and/or flow rate of the water and/or nutrient solution flow prevailing in the supply line or at the outlet 4 of the supply unit 2, i.e. at the nozzle outlets, can be selectively adjusted through selective activation of the delivery element 12. It is thus possible to vary both the range of the supply unit 2 in relation to the space into which water and/or nutrient solution is discharged and the jet shape of the water and/or nutrient solution flow coming out of the nozzles 6. In this context, it is conceivable, for example, for a jet to come out of the nozzles 6 at least intermittently, for the water and/or nutrient solution coming out to be atomized or, for an aerosol containing droplets of water and/or nutrient solution to be dispensed in the direction of plants or crops that are moved during their growth.

At the upper and lower ends of the guide rail shown on the left in FIG. 1, a contact sensor is provided as a sensor unit 14, which generates a signal upon contact with the strut-shaped nozzle holder 10 and transmits it to the control unit 19 so that it is ultimately possible to determine the movement speed, at least an average movement speed, of the nozzle holder 10 with the nozzles 6 fastened to it. Based on at least one determined speed value, it is ultimately possible for the drive 7 with a drive unit 20 such as an electric or hydraulic motor to be controlled with the aid of the control unit 10 and with the aid of stored set points in such a way that it is possible to vary the movement of the nozzle holder 10 with the nozzles 6 fastened to it, in particular its movement or travel speed. In this case, the travel speed is preferably set depending on the type of plants or fungi to be supplied with water and/or nutrient solution, depending on the respective growth phase, and/or depending on a selected day-night cycle. Accordingly, an irrigation and/or provision of nutrients can be carried out in a fully automatic way.

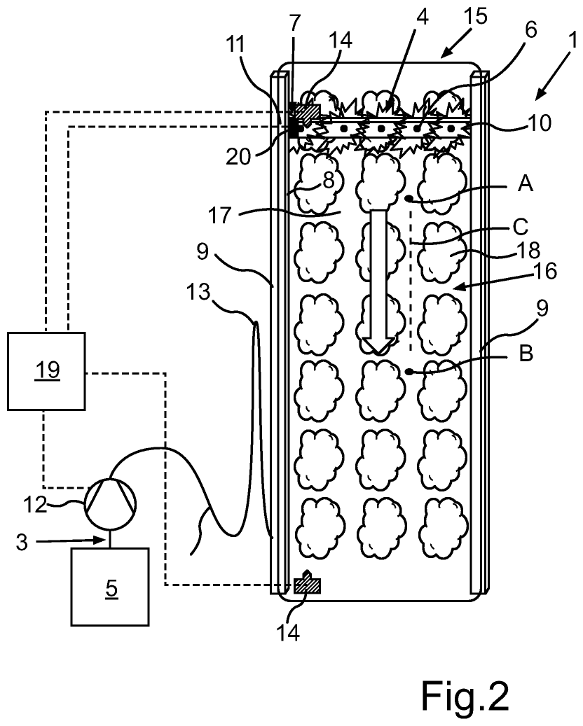

FIG. 2 shows a schematic depiction of a device 1 for irrigating and providing nutrients to plants and fungi, which is embodied according to the invention and in the exemplary embodiment shown, is combined with a system 15 for the automatic cultivation of crops 18, in particular plants and fungi. FIG. 2 shows an operating state in which heads of lettuce are being grown in the system 15 for automated plant cultivation and are anchored along a conveyor line on a conveyor belt 17 for this purpose. The conveyor line 17 has a plurality of conveyor sections 16 positioned between deflection points, on which the crops 18 to be grown or cultivated are alternately moved upward and downward. According to FIG. 2, the heads of lettuce to be grown are situated on a vertical conveyor section 16 of the system 15 for automated plant cultivation, with the root system projecting beyond the surface of the conveyor belt 17 in the direction of the device 1 for providing nutrients according to the invention. In this way, the root system is selectively provided with water and/or nutrient solution aeroponically by the moving nozzles 6 fastened to a nozzle holder 10. FIG. 2 shows a state of the device according to the invention in which the nozzle holder 10 with the nozzles 6 fastened to it is in the uppermost end position, touches the contact sensor provided as sensor unit 14 so that the electric motor of the drive 7 used as drive unit 20 is switched and the nozzle holder with the nozzles 6 fastened to it is then moved downward at a constant speed. Once again, it is essential that the nozzles 6 are moved to and dispense water and/or nutrient solution at locations A, B that are at different heights with respect to a vertical C. According to the embodiment shown in FIG. 2, the nozzles 6 are moved in a vertical plane that is at least approximately parallel to the plane in which the root systems of the plants to be grown are moved.

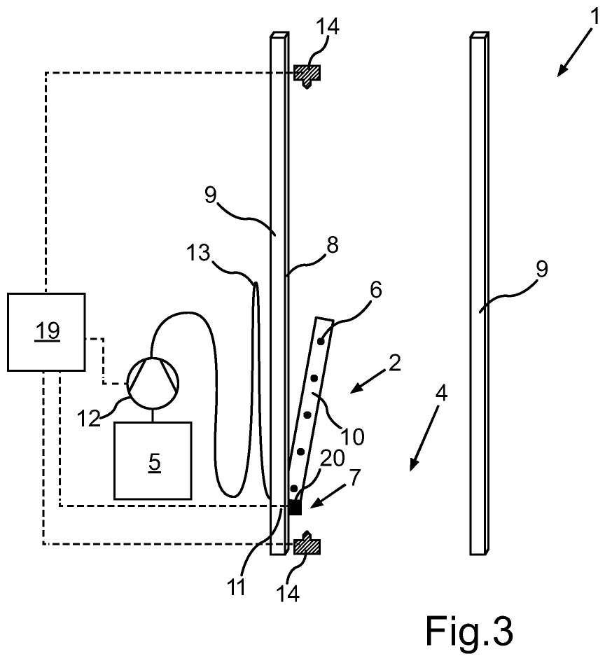

In addition, FIG. 3 shows a schematic depiction of a device 1 for providing plants or fungi with water and/or nutrient solution, which is embodied according to the invention and is in a maintenance state. In order to be able to suitably reach the nozzles 6 used as easily as possible for maintenance, repair, or replacement, a swivel and/or folding mechanism 11 is provided at one end of the nozzle holder so that the nozzle holder 10 can be folded upward together with the nozzles 6 fastened to it so that the nozzle holder 10 is then oriented at least approximately parallel to the guide rail 9 on the left in FIG. 3. Maintenance, repair, or replacement of nozzles can thus be carried out relatively easily from one side of the device for providing nutrients according to the invention.

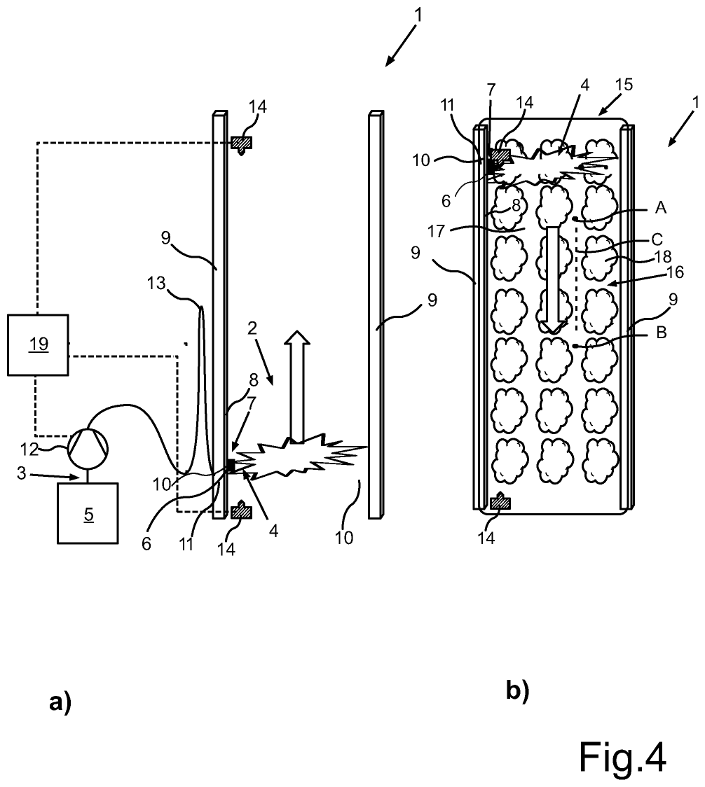

FIG. 4 shows another special embodiment of the invention. The essential technical feature of this embodiment is that a nozzle 6 is fastened to a vertical guide rail 9 by means of a suitable nozzle holder 10 in such a way that the nozzle 6 can be moved along the guide rail 9 in a vertical direction both upward and downward as needed and, in turn, nutrient solution can be dispensed in at least two locations (A, B), which are located at different heights above the floor, in the direction of the plants or fungi to be grown. It is generally conceivable for more than one nozzle to be moved along the guide rail 9. It is important here for the nozzle 6 to be located in the immediate vicinity of the vertical guide rail 9 and for the nozzle holder 10 to not protrude into the area in which the plants to be grown are positioned, thus reliably excluding the risk of damage to the plants or fungi, in particular the root system of the plants or the mycelium of the fungi.

During the movement of the nozzle 6 in a vertical direction along the guide rail, it is thus preferably possible to supply the areas of a plant or fungi growing system to be irrigated with a nutrient mist via the movable nozzle 6 without any part of the nozzle holder 10 protruding into the plant growing area. Preferably, the at least one nozzle 6, which can be moved with the aid of a drive train 8 and supplied with the corresponding liquid by a water and/or nutrient solution supply 5, is embodied as an air atomizing nozzle, which is characterized by the possibility of being able to dispense particularly fine mist with very small droplets over relatively long distances.

FIG. 4 shows the system 15 for irrigating plants or fungi in two different operating states, namely in FIG. 4 a) in an operating state in which no plants or fungi are positioned in the system 15 and the nozzle (6), which can be moved in a vertical direction, is situated in the lower region of the vertical guide rail 9 and in FIG. 4 b) in an operating state in which plants are positioned for cultivation and irrigation in the system 15 and the nozzle (6), which can be moved in a vertical direction, is situated in the upper region of the vertical guide rail 9. In the operating cases shown, the nozzle 6 will soon move upward according to FIG. 4 a) and will soon move downward according to FIG. 4 b).

In the upper and lower regions of the vertical guide rail 9, a sensor unit 14 is also provided, which generates a signal and transmits it to a control unit as soon as the nozzle 6 has reached an upper or lower reversal point, whereupon the control unit 19 generates a control signal and transmits it to the drive train 8 so that the nozzle 6 changes its movement direction. The sensor unit 14 is preferably embodied in the form of a touch sensor, which generates a signal as soon as the nozzle 6 touches a touch-sensitive surface of the sensor unit 14.

The movement of the nozzle 6 is in turn initiated by a suitable drive train 8, which in particular comprises a cable pull, a gear rod, a toothed rack, a pneumatic or hydraulic component, and/or an electric drive. The nozzle 6 is supplied with water and/or nutrients, in particular a suitable nutrient solution, via a suitable water and/or nutrient solution supply 5 with a supply line 13, through which the nutrient solution is pneumatically conveyed to the nozzle 6 with the aid of compressed air according to the exemplary embodiment shown in FIG. 4.

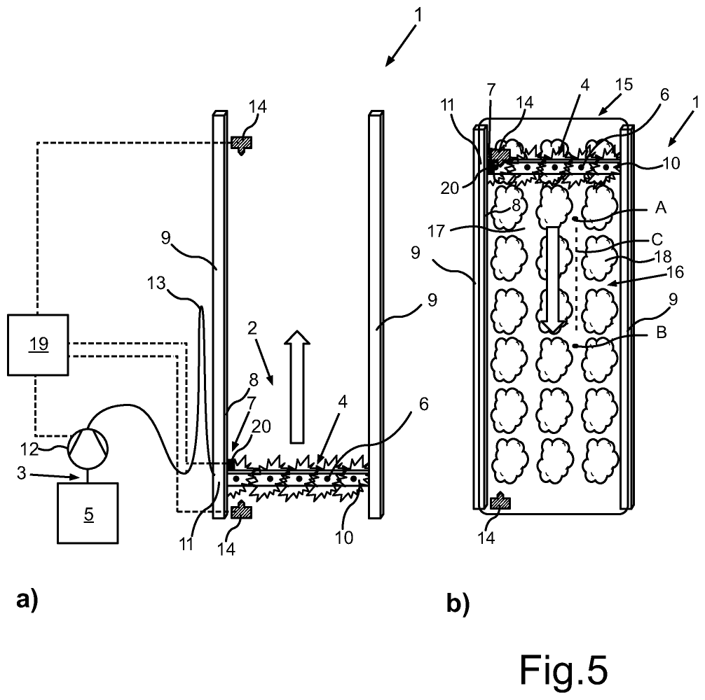

FIG. 5 shows another special embodiment of a system according to the invention and the implementation of the method according to the invention. According to this embodiment, the water used to irrigate plants or fungi and/or the nutrient medium, in particular a nutrient solution, is dispensed in the form of a fine mist with relatively small droplets via nozzles 6, which in this case are embodied as dispensing openings in a tube, in a selective manner over a large area in the direction of the plants or fungi, in particular the root system or the mycelium. In this case, the tube with the nozzles 6 can be moved both upward and downward in the vertical direction by means of a drive train 8 and is supplied with the required water and/or nutrient solution from a water and nutrient solution supply 5 via a supply line 13. According to the embodiment shown in FIG. 5, the mist is dispensed toward and in the immediate vicinity of the root or mycelium structures to be irrigated and with the aid of the pipe and the plurality of nozzles 6 provided therein. Once again, the upper and lower regions of the vertical guide rail 9 are provided with a sensor unit 14, which generates a signal and transmits it to a control unit 19 as soon as the pipe with the nozzles 6 has reached an upper or lower reversal point, whereupon the control unit 19 generates a control signal and transmits it to the drive train 8 so that the pipe with the nozzles 6 changes its movement direction. The sensor unit 14 is preferably embodied in the form of a touch sensor, which generates a signal as soon as the pipe touches a touch-sensitive surface of the sensor unit 14.

When the system 15 and the method according to FIG. 5 are used, if the nozzles 6 are embodied as pneumatic nozzles 6, then the mist can be selectively modulated in an advantageous way, i.e. in particular the droplet size and the spray pattern or geometry of the spray jet can be varied in a selective manner that is adapted to current needs.

FIG. 5 shows the system 15 for irrigating plants or fungi in two different operating states, namely in FIG. 5 a) in an operating state in which no plants or fungi are positioned in the system 15 and the pipe with nozzles (6), which can be moved in the vertical direction, is situated in the lower region of the vertical guide rails 9 and in FIG. 5 b) in an operating state in which plants for cultivation and irrigation are positioned in the system 15 and the pipe with nozzles (6), which can be moved in a vertical direction, is situated in the upper region of the vertical guide rails 9. In the operating cases shown, the pipe with the nozzles 6 will soon move upward according to FIG. 5 a) and will soon move downward according to FIG. 5 b).

### LIST OF REFERENCE SYMBOLS

1 device for irrigating and/or providing nutrients
2 supply unit
3 inlet
4 outlet
5 water and/or nutrient solution supply
6 nozzle
7 drive
8 drive train
9 guide rail
10 nozzle holder
11 swivel and/or folding mechanism
12 delivery element
13 supply line
14 sensor unit
15 system for automated cultivation of plants or fungi
16 conveyor section
17 conveyor belt
18 crop
19 control unit
20 drive unit
A first location for dispensing water and/or nutrient solution
B second location for dispensing water and/or nutrient solution
C vertical

The invention claimed is:

1. A device (1) for irrigating and providing nutrients to plants and fungi, having a supply unit (2), which has an inlet (3) that can be connected at least indirectly to a water and/or nutrient solution supply (5) and which has an outlet (4) through which water and/or nutrient solution can be dispensed in at least two locations (A, B) that are positioned at different heights with respect to a vertical (C),
characterized in that the supply unit (2) has a drive train (8), which can be connected to a drive unit (7), and at the outlet (4), has at least one nozzle (6), which is coupled to the drive train (8) and is for dispensing the water and/or nutrient solution, wherein based on an activation of the drive train (8), the nozzle (6) is movable to at least two locations (A, B) positioned at different heights.

2. The device according to claim 1, characterized in that the drive train (8) has at least one at least approximately vertically oriented guide rail (9) to which the nozzle (6) is at least indirectly connected and in relation to which the nozzle (6) executes a relative movement upon activation of the drive train (8).

3. The device according to claim 2, characterized in that the nozzle (6) is at least indirectly connected to the at least one guide rail (9) by means of a nozzle holder (10).

4. The device according claim 2, characterized in that a swivel and/or folding mechanism (11) is provided between the nozzle holder (10) and the at least one guide rail (9).

5. The device according to claim 1, characterized in that the drive train (8) has at least one support arm with at least one articulation to which the nozzle (6) is at least indirectly fastened and by means of which the nozzle (6) is movable to the at least two locations (A, B) that are positioned at different heights.

6. The device according to claim 1, characterized in that the supply unit (2) has at least one delivery element (12) by means of which a pressure and/or flow rate of a water and/or nutrient solution flow that is delivered to the nozzle (6) is selectively variable at least in certain areas.

7. The device according to claim 1, characterized in that the drive train (8) is coupled to a drive (7) with at least one electric, pneumatic, and/or hydraulic drive unit (20) for activation.

8. The device according to claim 1, characterized in that the drive train (8) is coupled to a drive (7) with at least one hydraulic drive unit (20) for activation, to which water and/or nutrient solution provided for the provision of nutrients is supplied as a drive fluid.

9. The device according to claim 1, characterized in that at least one sensor unit (14) is provided, which is able to detect a position, speed, and/or acceleration of the nozzle (6).

10. The device according to claim 1, characterized in that by means of a nozzle holder (10), a nozzle (6) is fastened in the immediate vicinity of a vertically oriented guide rail (9) and is able to move in the vertical direction in the immediate vicinity of the vertically oriented guide rail and by means of the nozzle, the water and/or nutrient solution can be dispensed in the direction of the plants or fungi.

11. The device according to claim 1, characterized in that the nozzle (6) is embodied as an air atomizing nozzle.

12. The device according to claim 1, characterized in that a plurality of nozzles (6) is embodied in the form of openings in a pipe that is movable in the vertical direction along a guide rail (9).

13. The device according to claim 1, characterized in that the control unit (19), the water and nutrient solution supply (5), and the at least one nozzle (6) are equipped in such a way that the water and/or nutrient solution can be dispensed in the form of mist, wherein it is possible to selectively vary a size of the droplets of the mist and/or a geometry of a dispensed spray jet

14. A method for irrigating and/or providing nutrients to plants and fungi, in which water and/or a nutrient solution is supplied to a supply unit (2) and the water and/or nutrient solution is dispensed from an outlet (5) of the supply unit (2) to a vicinity in which the plants and/or fungi are positioned, in at least two locations (A, B), which are at different heights with respect to a vertical
characterized in that at least one nozzle (6) is moved by a drive train (8), which can be activated by a drive (7), to at least two of the locations (A, B) positioned at different heights in order to dispense the water and/or nutrient solution.

15. The method according to claim 14, characterized in that the nozzle (6) is moved in the vertical and horizontal direction.

16. The method according to claim 14, characterized in that the nozzle (6) is moved with a constant speed at least during a movement between two reversal points.

17. The method according to claim 14, characterized in that a direction, pressure, flow rate, and/or jet shape with which the water and/or nutrient solution is dispensed into the vicinity in which the plants and/or fungi are positioned is/are varied.

18. The method according to claim 14, characterized in that the water and/or nutrient solution is dispensed in the form of a mist in the direction of the plants or fungi.

19. A system (15) for automated plant and fungi cultivation, having a device (1) according to claim 1.

20. The system for automated plant and fungi cultivation according to claim 19, having at least one conveyor section (16) on which the plants and/or fungi to be grown are moved upward or downward in an at least approximately vertical direction, wherein the plants and/or fungi are anchored relative to a conveyor belt (17) moving along the conveyor section (16) in such a way that the root system of the plants and mycelia of the fungi project on one side of the conveyor belt (17) and the root system is at least intermittently provided with water and/or nutrient solution.
